(19) United States
(12) Patent Application Publication
(10) Pub. No.: US 2011/0134466 A1
(43) Pub. Date: Jun. 9, 2011

(54) PRINT SERVER, METHOD FOR GENERATING PRINT SETTING SCREEN, AND STORAGE MEDIUM

(75) Inventor: Masashi Nakagawa, Sagamihara-shi (JP)

(73) Assignee: CANON KABUSHIKI KAISHA, Tokyo (JP)

(21) Appl. No.: 12/911,600

(22) Filed: Oct. 25, 2010

(30) Foreign Application Priority Data
Dec. 9, 2009 (JP) 2009-279825

(51) Int. Cl. G06F 15/00

(52) U.S. Cl. 358/1.15

(57) ABSTRACT

A print server includes a receiving unit configured to receive, from a printer, user information input in the printer, a storage unit configured to store the user information received by the receiving unit, an acquisition unit configured to acquire user information issued from a client apparatus, and a generation unit configured to generate, when user information that matches the user information acquired by the acquisition unit is stored in the storage unit, a print setting screen based on a function of a printer associated with the user information, and to generate, when user information that matches the user information acquired by the acquisition unit is not stored in the storage unit, a print setting screen based on functions of a plurality of printers.

### BACKGROUND OF THE INVENTION

1. Field of the Invention

The present invention relates to a print server, a method for generating a print setting screen, and a storage medium.

2. Description of the Related Art

In recent years, uniform management and mobile personal computerization of document data, and implementation of a thin client have been increasingly accelerated. Therefore, a client personal computer (PC) requires an environment where printing is performed without installing a printer driver. As a problem occurring without installing the printer driver, a print setting screen corresponding to a printer that outputs print documents cannot be displayed as before, and print setting most suitable for the printer cannot be performed.

In order to solve this problem, there are solving methods, described below.

For example, Japanese Patent Application Laid-Open No. 2003-162388 discusses a technique for acquiring the respective capabilities of printer groups to be managed and displaying only setting items that can be set by all the printer groups according to their combinations.

In Japanese Patent Application Laid-Open No. 2003-162388, all printer drivers for printer groups to be managed are to be previously installed into a client PC. When printing is performed by specifying a printer, the printer cannot make the most of a specified printer function because “only setting items that can be set by all printer groups” are displayed in a technique discussed in Japanese Patent Application Laid-Open No. 2003-162388, although it originally has a large number of functions. In a free-address office environment where mobile personal computerization, previously described, has progressed, for example, a user generally designates a printer closest thereto and desires to output print documents from the printer at the time of printing. In this case, in Japanese Patent Application Laid-Open No. 2003-162388, the user is to check an output port connected to the printer on a client PC and to select a printer driver by himself/herself. If the printer has a stapling function, but the printer group excluding the printer does not have a stapling function, the stapling function cannot be set.

### SUMMARY OF THE INVENTION

The present invention is directed to displaying an optimum print setting screen depending on whether a user designates a printer that the user desires to use for printing without installing a printer driver into a client PC.

According to an aspect of the present invention, a print server includes a receiving unit configured to receive, from a printer, user information input in the printer, a storage unit configured to store the user information received by the receiving unit, and a generation unit configured to generate, when user information that matches the user information acquired by the acquisition unit is stored in the storage unit, a print setting screen based on a function of a printer associated with the user information, and to generate, when user information that matches the user information acquired by the acquisition unit is not stored in the storage unit, a print setting screen based on functions of a plurality of printers.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 illustrates an example of a system configuration of a printing system according to an exemplary embodiment of the present invention.

FIG. 2 illustrates a hardware configuration of a server and a printer associated with printing processing of a printing system.

FIG. 3 illustrates a functional configuration of a server and a printer associated with printing processing of a printing system.

FIG. 4 is a flowchart illustrating an example of processes performed when a print server receives user information from a designated output destination printer.

FIG. 5 illustrates an example of a user information list storage area.

FIG. 6 is a flowchart illustrating an example of processes up to display of a print setting user interface (UI).

FIG. 7 illustrates an example of a print setting UI screen including a print setting screen generated in step S116.

FIG. 8 illustrates an example of a print setting UI screen including a print setting screen generated in step S119.

FIG. 9 illustrates an example of a list of functions of each printer used to generate a general-purpose print setting UI.

FIG. 10 illustrates an example of a print setting UI having functions, i.e., “effective period of printer” and “setting of default printer” added thereto.

FIG. 11 illustrates an example of a list of expiration date (effective periods) set in an effective period of a printer.

FIG. 12 illustrates an example of a user information list obtained by adding a date and time on and at which a printer is designated, a date and time on and at which final printing is performed, an effective period of the printer, and information as to whether the printer is a default printer to a user information list illustrated in FIG. 8.

FIG. 13, composed of FIGS. 13A and 13B, is a flowchart illustrating an example of processes up to display of a print setting UI when a user designates a plurality of output destination printers.

FIG. 14 illustrates an example of a print setting UI screen.

FIG. 15 illustrates an example of a print setting UI screen.

### DESCRIPTION OF THE EMBODIMENTS

Various exemplary embodiments, features, and aspects of the invention will be described in detail below with reference to the drawings.

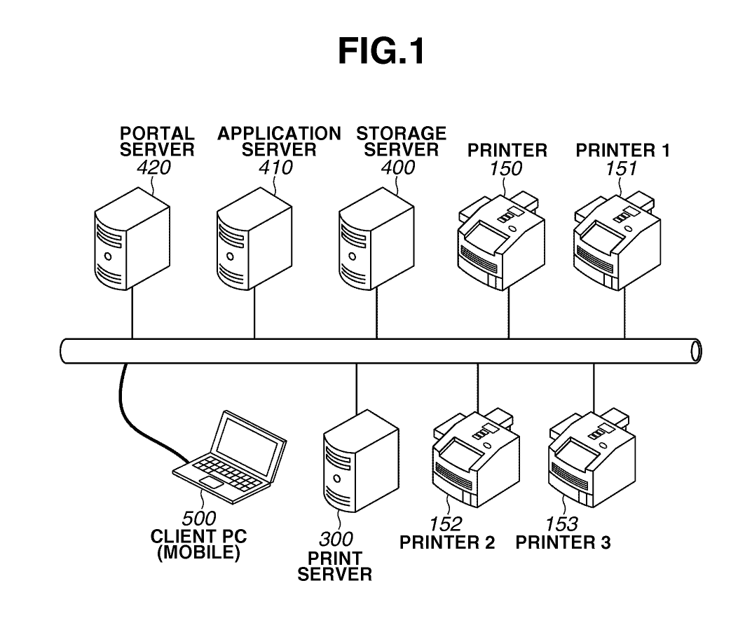

FIG. 1 illustrates an example of a system configuration of a printing system according to a first exemplary embodiment of the present invention. The printing system according to the present exemplary embodiment includes at least a print server 300, a printer 150, and a client PC 500. Further, a storage server 400 storing all digital data, including document data, and an application server 410 for managing an application for generating a document are connected to the printing system. The printing system also includes a portal server 420 for providing a portal site favorable to manage each apparatus with a web service. While a printer 1 (151), a printer 2 (152), and a printer 3 (153) are also further connected to the printing system in FIG. 1, the printing system may further include a plurality of printers in the present exemplary embodiment.

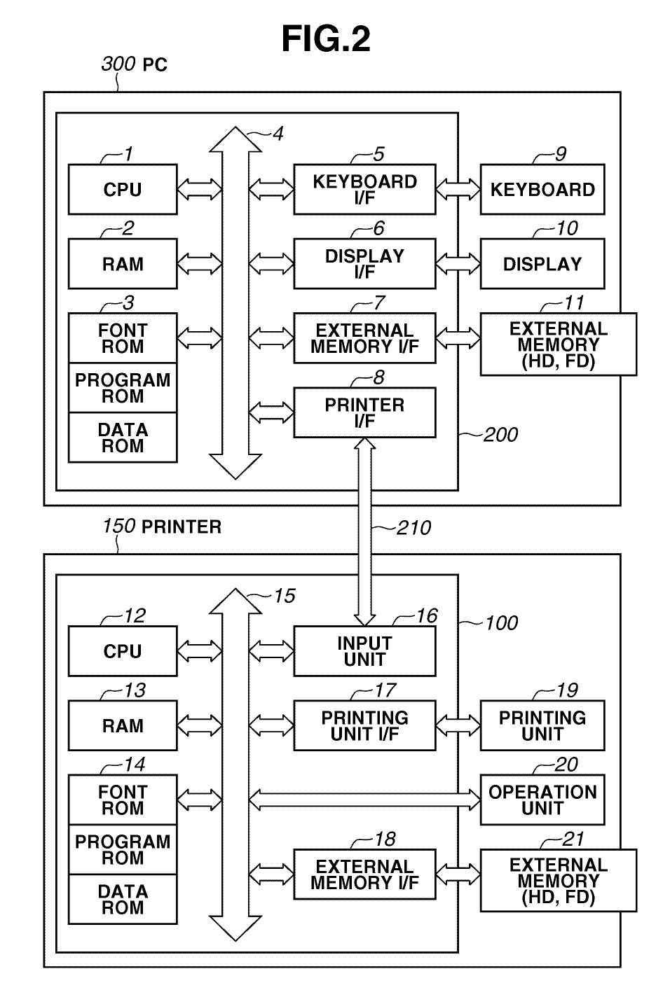

FIG. 2 illustrates a hardware configuration of a server and a printer associated with printing processing of the printing system. A host computer 300 includes a central processing unit (CPU) 1 for executing document processing including a mixture of a graphic, an image, a character, and a table (including a spreadsheet), and so on based on a document processing program stored in a program ROM in a read-only memory (ROM) 3 or an external memory 11. Further, the CPU 1 collectively controls devices connected to a system bus 4. The program ROM in the ROM 3 or the external memory 11 stores an operating system (hereinafter referred to as an OS) program serving as a control program for the CPU 1. The font ROM in the ROM 3 or the external memory 11 stores font data or the like used when the document processing is performed, and a data ROM in the ROM 3 or the external memory 11 stores various types of data used when the document processing is performed. A random access memory (RAM) 2 functions as a main memory, a work area, or the like in the CPU 1. A keyboard interface (I/F) 5 controls key input from a keyboard 9 or a pointing device (not illustrated). A display I/F 6 controls display on a display 10. An external memory I/F 7 controls access to the external memory 11 such as a hard disk (HD) or a flexible disk (FD). The external memory 11 stores a boot program, various types of applications, font data, a user file, an edit file, a printer driver, and so on. A printer I/F 8 is connected to a printer 150 via a predetermined bidirectional interface 210, to perform communication control processing with the printer 150.

The CPU 1 rasterizes an outline font to a display information RAM set on the RAM 2, for example, to enable what-you-see-is-what-you-get (WYSIWYG) on the display 10. The CPU 1 opens various types of windows registered based on a command issued with a mousse cursor (not illustrated) or the like on the display 10, to execute various types of data processing. A user opens, when the printing is performed, the window relating to setting of the printing, to set a printer and set a printing processing method for a printer driver including selection of a print mode. In the present exemplary embodiment, the host computer 300 is described as a print server (a print server apparatus).

Hardware configurations of servers other than the print server are similar to a hardware configuration of the host computer 300. A CPU in each of the servers executes processing based on a program stored in the ROM or the external memory, to implement a function of the server.

In the printer 150, the CPU 12 outputs an image signal serving as output information to a printing unit (printer engine) 19 via a printing unit I/F 17 connected to a system bus 15 based on a control program or the like. The control program is stored in the program ROM in the ROM 14, an external memory 21, and so on. A font ROM in the ROM 14 stores font data used when the output information is generated, and a data ROM in the ROM 14 stores information used on the host computer 300 if the printer 150 does not have the external memory 21 such as the hard disk. The CPU 12 enables communication with the host computer 300 via an input unit 16, and enables communication of information or the like in the printer 150 with the host computer 300. A RAM 13 functions as a main memory, a work area, or the like in the CPU 12, and can enhance a memory capacity by an option RAM connected to an expansion port (not illustrated). The RAM 13 is used for an output information rasterization area, an environmental data storage area, a non-volatile (NV) RAM, and so on. A memory controller (MC) 18 controls access to the external memory 21 such as the hard disk (HD) or an integrated circuit (IC) card. The external memory 21 is connected as an option, and stores font data, an emulation program, form data, and so on. An operation unit 20 is an operation panel, where a switch and a light emitting diode (LED) display for an operation are disposed. The printer 150 may include not only one external memory but also at least one external memory. A plurality of external memories each storing an option font card, and a program for interpreting printer control languages that differ in language systems in addition to a built-in font. Further, the printer 150 may have an NVRAM (not illustrated), and store printer mode setting information from the operation unit 20.

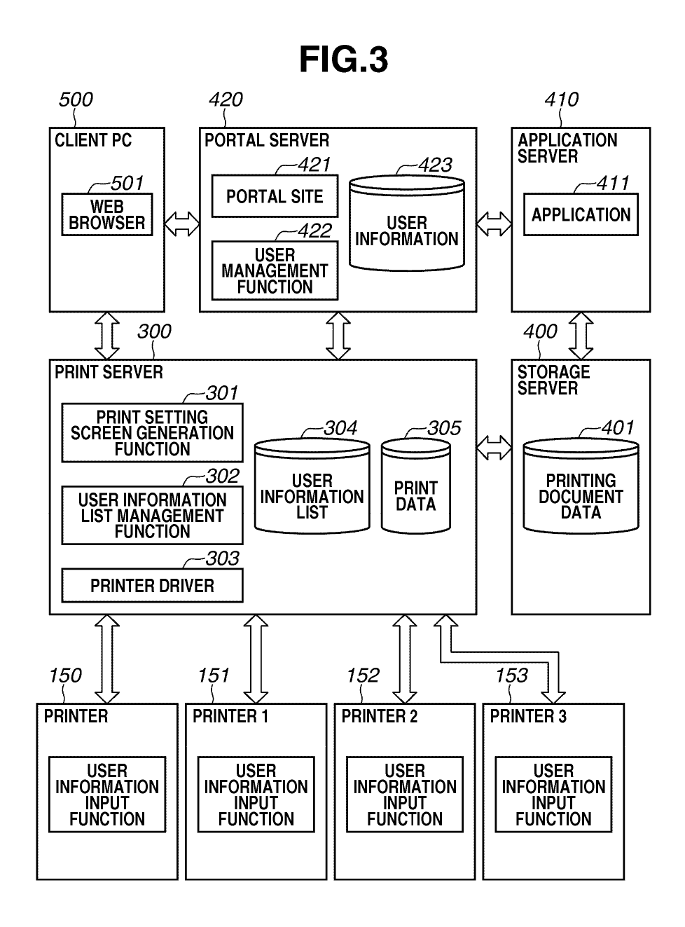

FIG. 3 illustrates a functional configuration of the server and the printer associated with the printing processing of the printing system. A client PC 500 has only a web browser 501 installed therein, and does not store a printer driver for specifying an output printer. An application server 410 has an application 411 capable of browsing and editing document data from the web browser 501 in the client PC 500 installed therein. A storage server 400 includes a memory for storing the document data generated by the application 411. A portal server 420 provides a portal site 421 for managing web contents (portlet services) provided from various types of web applications. In the present exemplary embodiment, the portal server 420 includes a function 422 for performing user management. User authentication is required to access the portal server 420 from each of client PCs 500. User information is input to printer groups 150 to 153 for the user to designate the output printer. General input methods include a method for a user to hold a card storing user information over a device provided in a printer and read the user information and a method for a user to input a user identification (ID) and a password to log on. The print server 300 contains a user information list storage area 304 storing each of the user information acquired from the printer groups 150 to 153 having user information input functions. Further, a print setting screen generation function 301, a user information list management function 302, and a printer driver 303 are installed into the print server 300. They are program modules stored in the external memory 11, loaded in the RAM 2 by an instruction from an OS program or another program using the program, and executed by the CPU 1. The print setting screen generation function 301, the user information list management function 302, and the printer driver 303 are added to the HD serving as the external memory 11 via the FD serving as the external memory 11, a compact disk (CD)-ROM (not illustrated), or a network (not illustrated). The print server 300 also contains a storage area for storing and placing print data, which is not directly related in the present exemplary embodiment.

A representative flow in the present exemplary embodiment will be described below with reference to FIG. 3 illustrating a configuration of the server and the printer associated with the printing processing of the printing system. The client PC 500 previously uses the application 411 in the application server 410, to generate document data, and store the document data in print document data 401 in the storage server 400. The client PC 500 uses the web browser 501, to start the portal site 421 in the portal server 420. The portal server 420 instructs the print server 300 to start a print setting screen at timing of starting the portal site 421. The print server 300 that has received an instruction to start the print setting screen receives user information relating to a user of the client PC 500, and acquires printable data from the print document data 401 in the storage server 400 based on the user information. Further, the print server 300 searches the user information list storage area 304 for a printer designated by the user information based on the user information. The print server 300 generates a print setting screen according to the effective printer as a result of the search, and provides the print setting screen to the portal server 420.

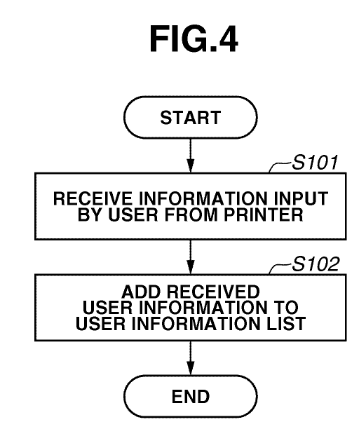

A processing flow in a case where the print server 300 receives user information from a designated output destination printer will be described with reference to FIG. 4. A flowchart executed in the print server is implemented by the CPU 1 in the print server 300 reading out a program associated with the flowchart and executing the read program.

In step S101, the print server 300 acquires (receives) user information input when a user designates an output destination printer from the printer. In step S102, the print server 300 adds the user information received from the printer to the user information list storage area 304 (stores the user information).

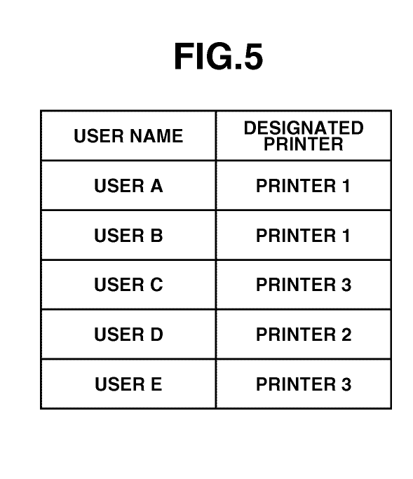

FIG. 5 illustrates an example of the user information list storage area 304. The user information list storage area 304 stores information as to which of printers each user designates (one or more user information) as a list.

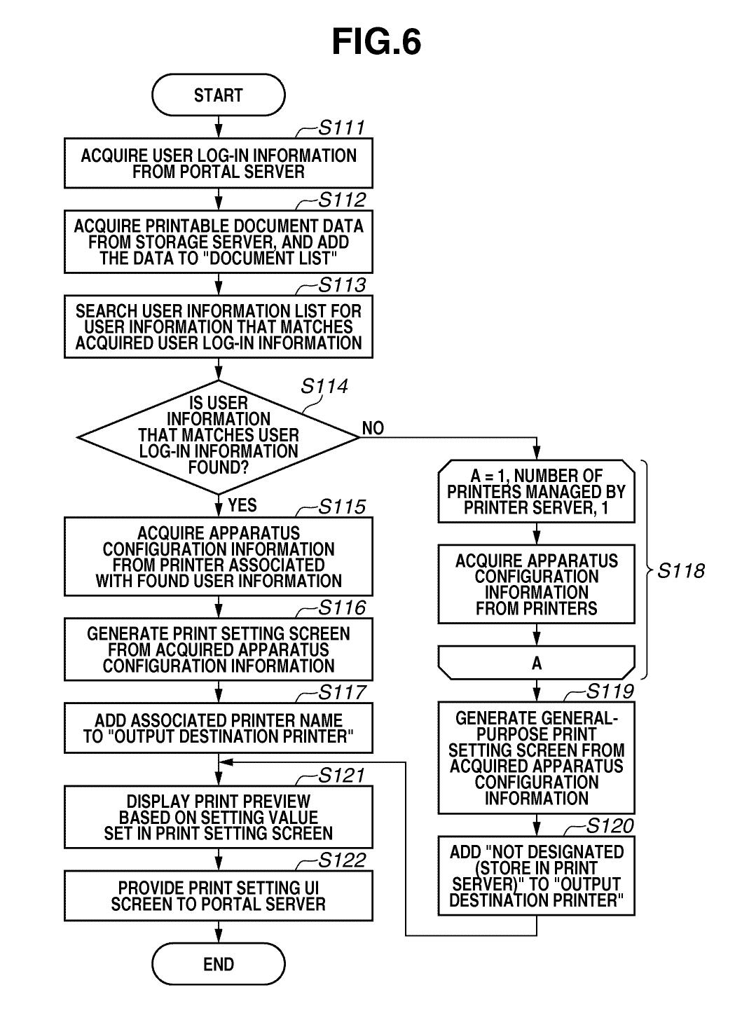

A flow up to display of a print setting UI will be described with reference to FIG. 6. In step S111, the print server 300 receives a notification to start a print setting screen from the portal server 420, and receives user log-in information from the portal server 420. In step S112, the print server 300 uses the acquired user log-in information, to acquire printable document data from the storage server 400, and adds the acquired document data to “document list”. In step S113, the print server 300 searches the user information list storage area 304 for user information that matches the acquired user log-in information. In step S114, the print server 300 determines whether the user information that matches the acquired user log-in information is found as a result of the search. If the user information that matches the user log-in information is found (YES in step S114), the processing proceeds to step S115. In step S115, the print server 300 uses a driver of a printer associated with the found user information, to acquire apparatus configuration information. The apparatus configuration information is also referred to as functional information. In step S116, the print server 300 generates “print setting screen” from the acquired apparatus configuration information. In step S117, the print server 300 adds a printer name of the associated printer to “output destination printer name”. In step S121, the print server 300 generates and displays “print preview image” according to print document data selected in “document list” and a setting value set in “print setting screen”. In step S122, the print server 300 provides a generated print setting UI screen to the portal server 420.

If the user information that matches the acquired user log-in information is not found as a result of the search (NO in step S114), the processing proceeds to step S118. In step S118, the print server 300 acquires apparatus configuration information from all printers to be managed. In step S119, the print server 300 generates a general-purpose print setting screen (a print setting screen corresponding to a plurality of printers) from the acquired apparatus configuration information. In step S120, the print server 300 adds “not designated (store in print server)” to “output destination printer name”.

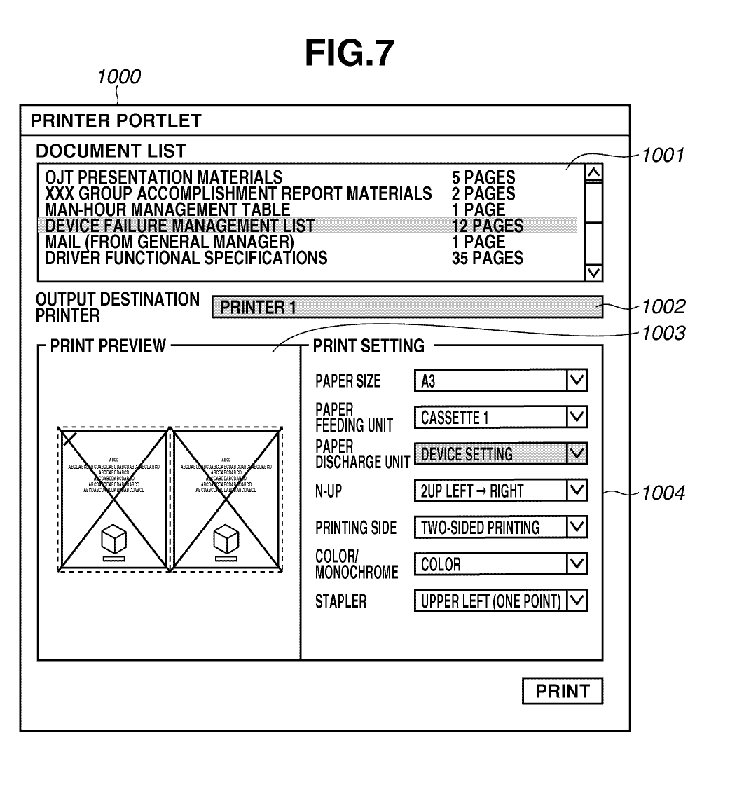

FIG. 7 illustrates an example of “print setting UI screen” 1000 including “print setting screen” 1004 generated in step S116. “Print setting UI screen” 1000 includes “print document list” 1001 acquired from the storage server 400, “output destination printer name” 1002, and “print preview screen” 1003 on which setting values set in “print setting screen” 1004 are reflected. In the present exemplary embodiment, the user designates “Printer1” as an output destination printer, so that “Printer1” is selected in “output destination printer name” 1002.

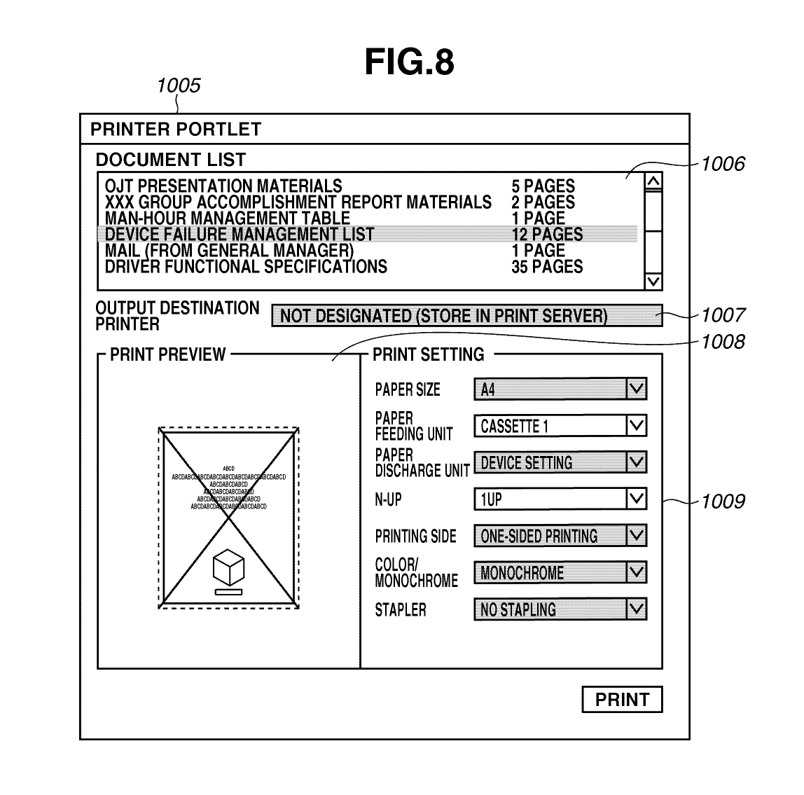

FIG. 8 illustrates an example of “print setting UI screen” 1005 including “print setting screen” 1009 generated in step S119. Similarly to FIG. 7, “print setting UI screen” 1005 includes “print document list” 1006, “print preview screen” 1008, and “print setting screen” 1009. “Not designated (store in print server)” is displayed in “output destination printer name” 1007. This does not indicate that a user goes in front of a printer and designates an output destination printer before displaying a print setting screen. This case assumes that “pull printing” for storing and placing print documents on the print server 300 until an instruction for printing is issued from the printer without directly outputting the print documents to the printer is performed when printing is actually performed. If “pull printing” is performed without designating an output destination printer when printing is performed, a printer that actually performs printing is not determined, so that a general-purpose print setting screen is displayed. By “general-purpose” is meant “setting only a printing function that always enables printing to be performed and “setting all printing functions that does not always enable printing to be actually performed” out of the printer groups managed by the print server 300. In the present exemplary embodiment, while “general-purpose print setting screen” 1009 aiming at “setting only a printing function that always enables printing to be performed” is taken as an example, the present invention is not limited to this.

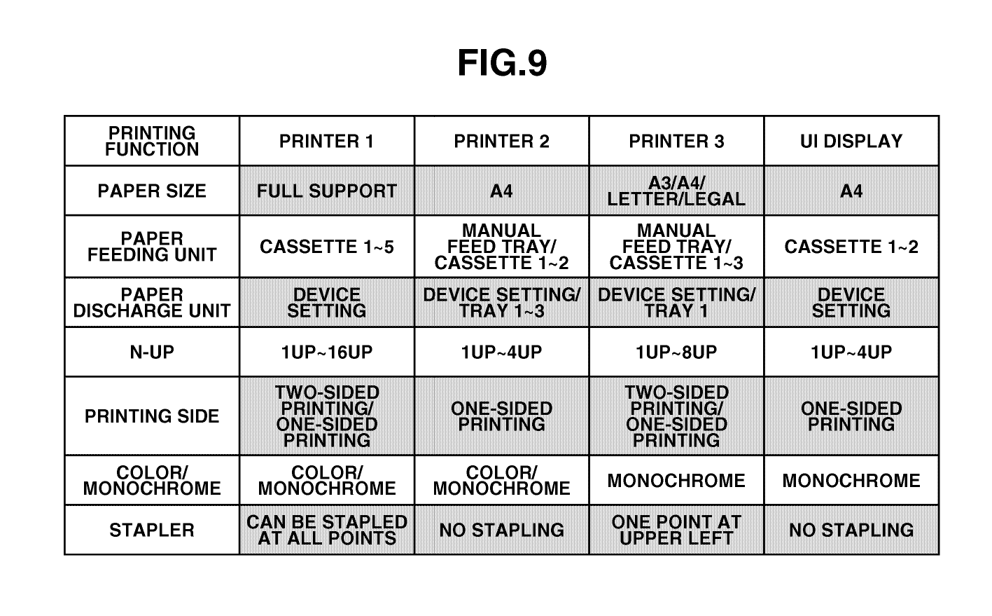

FIG. 9 illustrates an example of a list of functions of each of printers used to generate “general-purpose print setting UI screen” 1005. In the present exemplary embodiment, the printers managed by the print server 300 include a printer 1 (151), a printer 2 (152), and a printer 3 (153). In a column “UI display”, only the printing function that always enables printing to be performed is taken out of the respective printing functions of the printers. When “print setting screen” 1009 is generated, selection items “paper size”, “paper discharge unit”, “printing side”, “color/monochrome”, and “stapler” each having only one option are grayed-out. More specifically, in the selection item “paper size”, only A4 is common among the printers 1 to 3, so that only A4 is an option. As a result, there is any other option. Therefore, the selection item “paper size” is grayed-out in FIG. 8.

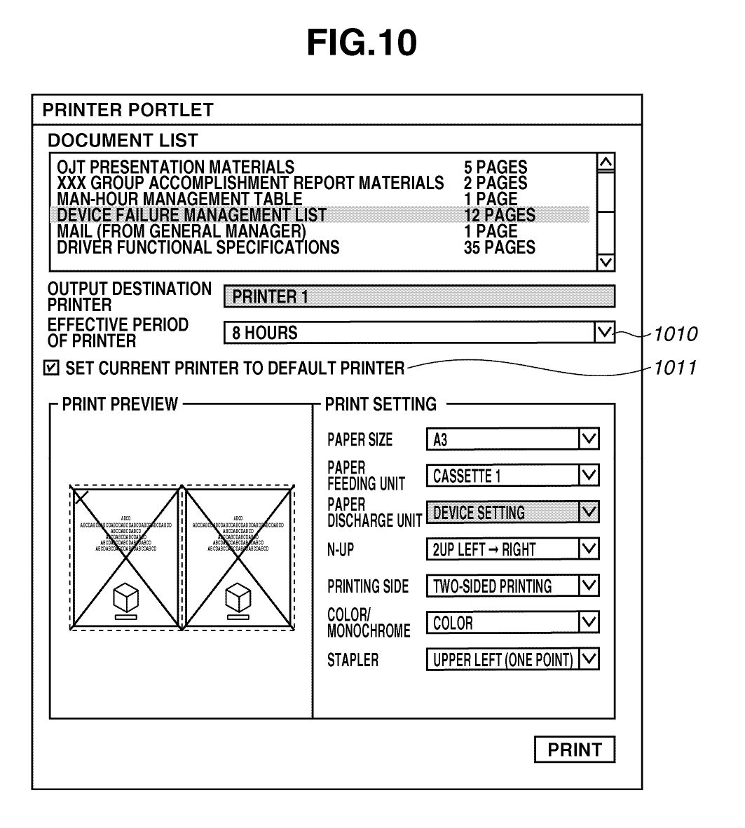

FIG. 10 illustrates an example of a print setting UI to which two functions, described below, are added in the present exemplary embodiment. The first function is a function 1010 of setting an effective period of a printer designated by a user (an effective period setting function). The second function is a function 1011 of performing setting, even if a user does not designate an output destination printer in advance, to output print documents to the printer (a default printer setting function for setting the printer to a default printer).

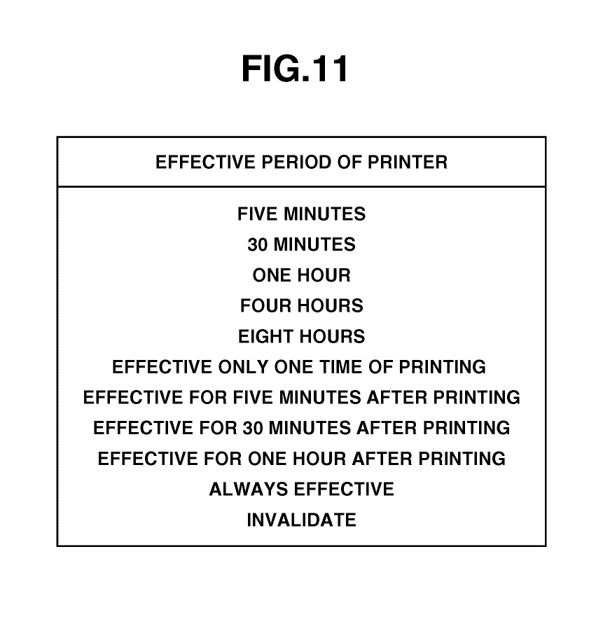

FIG. 11 illustrates an example of a list of expiration dates (effective periods) that can be set in “effective period of printer” 1010. Types of the effective period include one to be defined by a period of time elapsed since a user has designated a printer, one to be defined by the number of times of printing, one to be defined by a period of time elapsed since printing has been performed, one to be made always effective, and one to be made always ineffective.

The print server 300 adds the set information to a user information list at the time of printing.

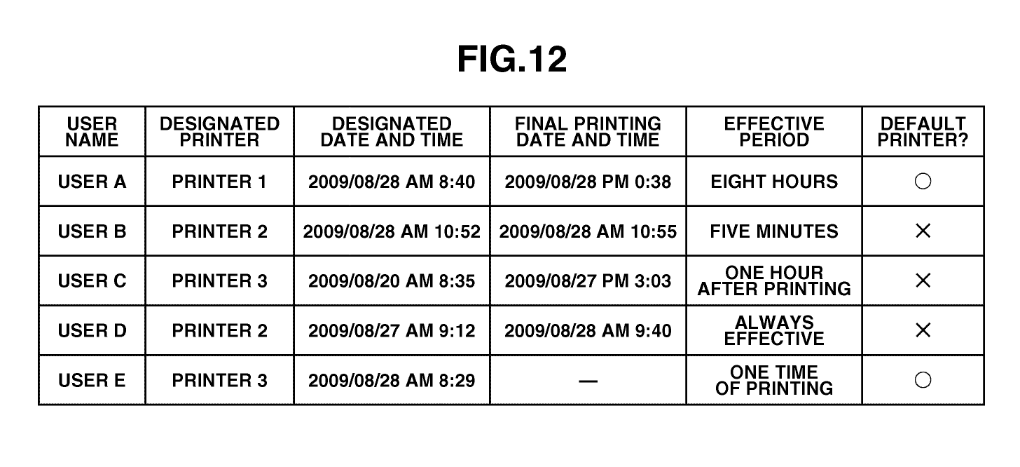

FIG. 12 illustrates an example of a user information list obtained by adding a date and time on and at which a printer is designated, a date and time on and at which final printing is performed, an effective period of the printer, and information as to whether the printer is a default printer to the user information list illustrated in FIG. 8. The print server 300 determines whether a registered printer is effective or ineffective based on information relating to the user information list at timing of generating a print setting UI.

If the user goes in front of a printer and designates an output destination printer before the print setting UI is displayed by the processes according to the present exemplary embodiment, a print setting screen most suitable for the printer is displayed. On the other hand, if the user does not designate the output destination printer, a general-purpose print setting screen can be displayed according to a printer group managed by the print server 300.

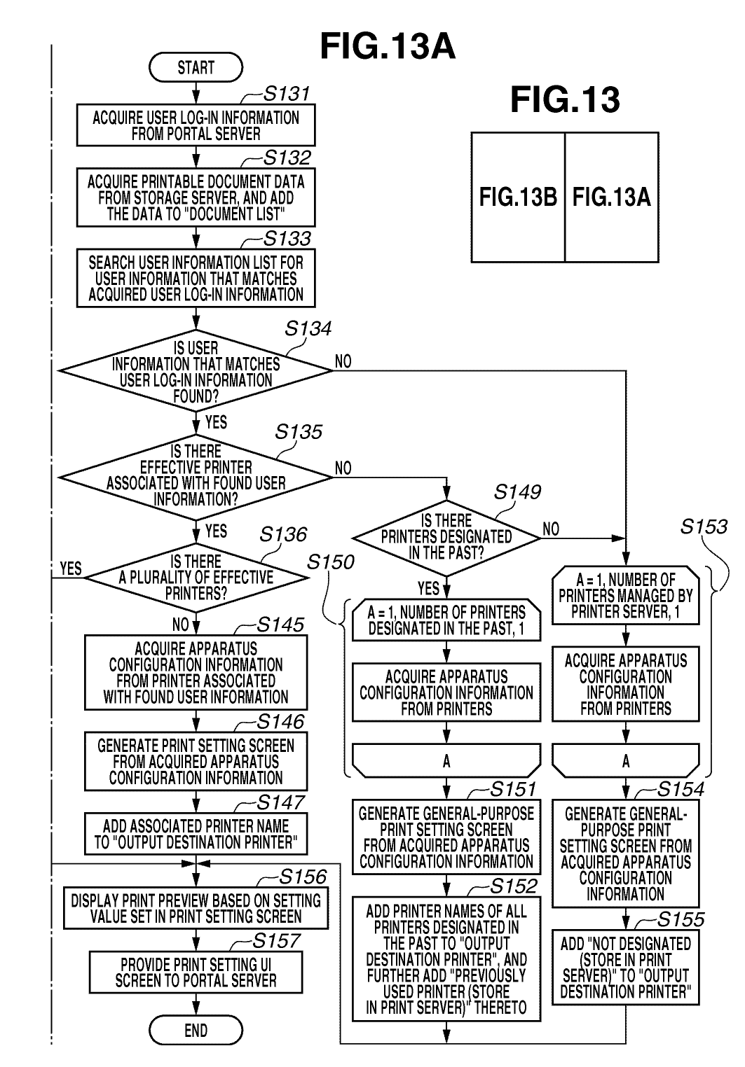

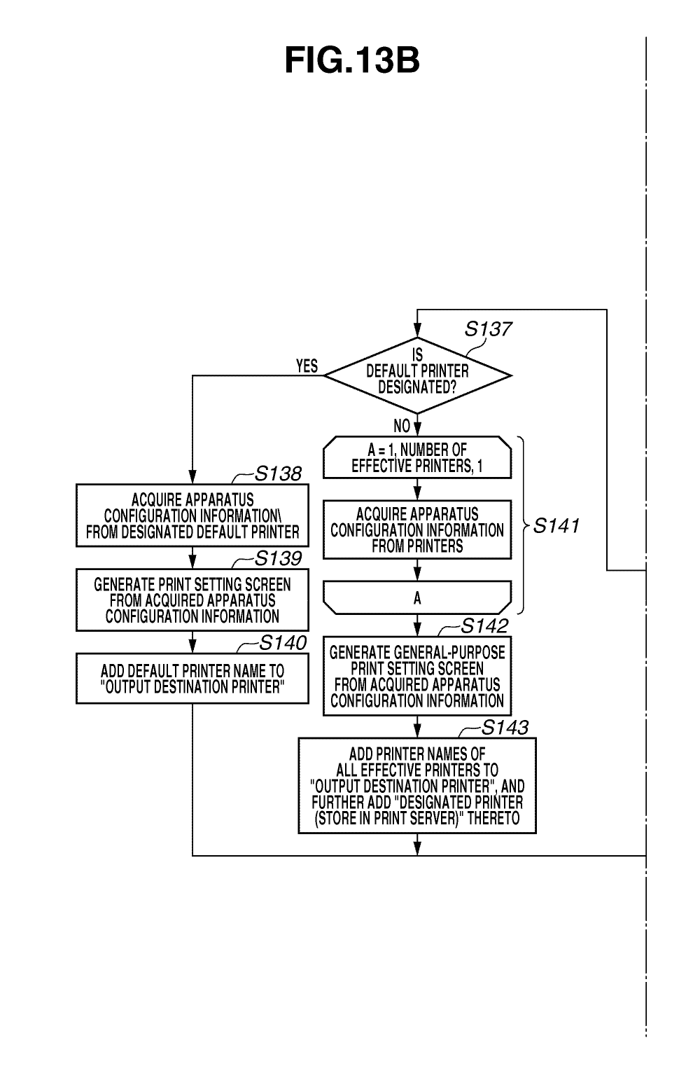

The first exemplary embodiment assumes that each user designates only one printer and not assumes that a plurality of printers is designated. In a second exemplary embodiment of the present invention, a flow up to display of a print setting UI in a case where a user designates a plurality of printers as an output destination printer will be described with reference to FIG. 13, which is composed of FIGS. 13A and 13B.

Steps S131 to S134 are similar to steps S111 to S114 in the first exemplary embodiment and hence, the description thereof is not repeated. If user information that matches the user log-in information is found (YES in step S134), the processing proceeds to step S135. In step S135, a print server 300 checks whether there is an effective printer associated with the found user information. If there is an effective printer (YES in step S135) and there is a plurality of effective printers (YES in step S136), the processing proceeds to step S137. In step S137, the print server 300 checks whether a group of the printers includes the printer designated as a default printer. Information relating to the default printer is retained in the print server 300. If the default printer is designated (YES in step S137), the processing proceeds to step S138. In step S138, the print server 300 acquires apparatus configuration information from a driver of the default printer. In step S139, the print server 300 generates a print setting screen of the default printer. In step S140, the print server 300 displays a printer name of the default printer in “output destination printer name”. If the printer group does not include the printer designated as a default printer (NO in step S137), the processing proceeds to step S141. In step S141, the print server 300 acquires apparatus configuration information from all the printers in the printer group. In step S142, the print server 300 generates a general-purpose print setting screen from the acquired apparatus configuration information. In step S143, the print server 300 adds “designated printer (store in the print server)” to “output destination printer name”. Processes (steps S145 to S147) performed when only one effective printer exists are similar to steps S115 to S117 in the first exemplary embodiment and hence, the description thereof is not repeated. Further, a print preview display process (step S156) and a print setting UI provision process (step S157) are similar to steps S121 and S122 in the first exemplary embodiment and hence, the description thereof is not repeated.

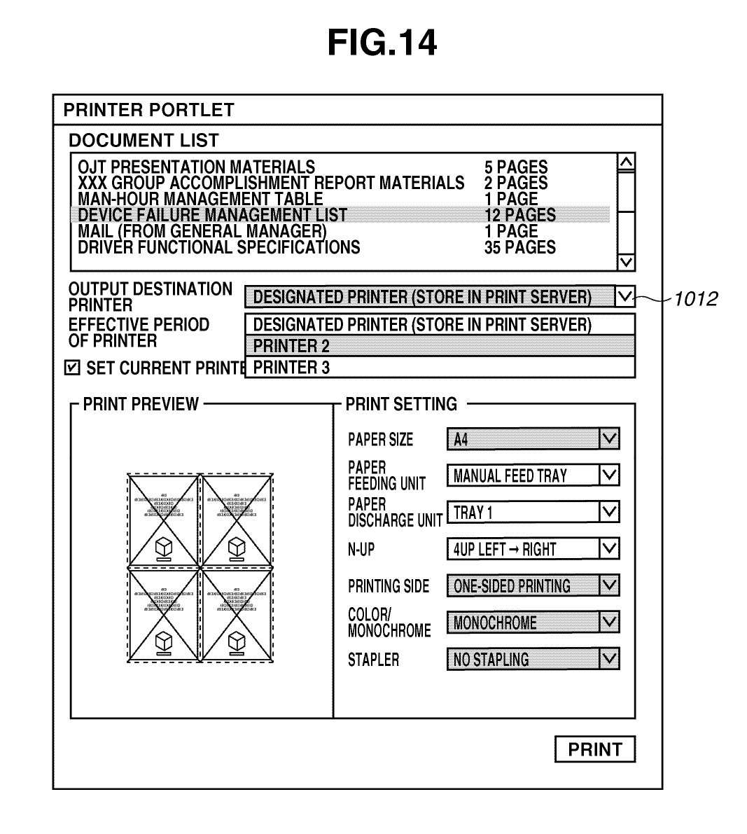

FIG. 14 illustrates an example of a print setting UI screen. If a user selects a cursor for “output destination printer name” 1012 illustrated in FIG. 14, options are displayed. More specifically, in “output destination printer name” 1012 on the screen illustrated in FIG. 14, printer names of a plurality of printers designated by the user before the print setting UI screen is displayed and “designated printer (store in print server)” are displayed as the options. In the example illustrated in FIG. 14, the user goes in front of the printer 2 and the printer 3 before FIG. 14 is displayed, to input user information.

When the user selects “designated printer (store in print server)”, the print server 300 generates a general-purpose print setting screen of the designed plurality of printers (the printer 2 and the printer 3 in the example illustrated in FIG. 14).

Even if the user previously designates a plurality of output destination printers by the processes according to the present exemplary embodiment, a general-purpose print setting screen can be displayed according to a group of the designated printers.

Thus, a print setting screen of the printer designated by the user or a general-purpose print setting screen of the plurality of printers designated by the user are displayed.

The first exemplary embodiment and the second exemplary embodiment assume that there are one or more effective printers and do not assume that there is no effective printer. In a third exemplary embodiment of the present invention, a flow up to display of a print setting UI in a case where there exists no effective printer will be described with reference to FIG. 13.

Steps S131 to S135 are described in the second exemplary embodiment and hence, the description thereof is not repeated. If there is no effective printer (NO in step S135), the processing proceeds to step S149. In step S149, a print server 300 checks whether there is a printer designated previously by a user indicated by user information. More specifically, the print server 300 determines that there is a printer designated previously by the user indicated by the user information when a printer associated with the user information exists but its effective period expires.

If the printer designated previously exists (YES in step S149), the processing proceeds to step S150. In step S150, the print server 300 acquires apparatus configuration information of all printers used previously in the above-mentioned printer group. In step S151, the print server 300 generates a general-purpose print setting screen from the acquired apparatus configuration information. In step S152, the print server 300 adds “printer previously used (store in print server)” to “output designation printer name”.

Processes (steps S153 to S155) performed when there is no printer designated previously (NO in step S149) are similar to steps S118 to S120 in the first exemplary embodiment and hence, the description thereof is not repeated. Further, a print preview display process (step S156) and a print setting UI provision process (step S157) are similar to steps S121 and S122 in the first exemplary embodiment and hence, the description thereof is not repeated.

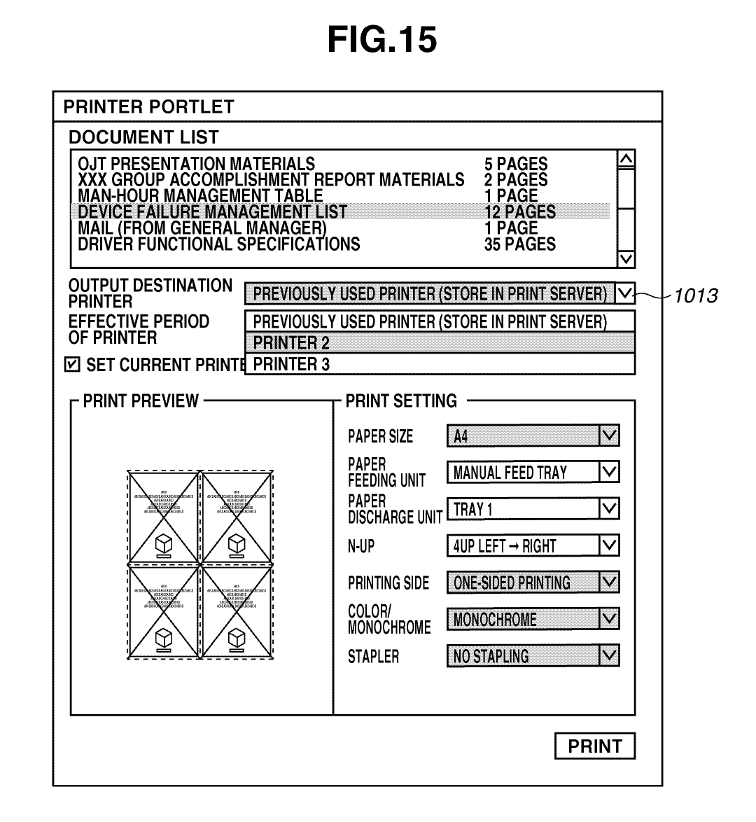

FIG. 15 illustrates an example of a print setting UI screen. A printer name of an ineffective printer that has been previously used (a printer the effective period of which expires) and “printer previously used (store in print server)” are added to “output destination printer name” 1013 on the screen. More specifically, in the example illustrated in FIG. 15, a printer 2 and a printer 3 that have been used previously are displayed when there is no printer designated by the user before FIG. 15 is displayed and there is no effective printer.

When the user selects “printer previously used (store in print server)”, the print server 300 generates a general-purpose print setting screen in a group of ineffective printers previously used.

The processes according to the present exemplary embodiment enable, if there is a printer used previously even when the user does not previously designate an output destination printer, a general-purpose print setting screen to be displayed according to the printer used previously.

Thus, a print setting screen of the printer designated by the user or a general-purpose print setting screen of the plurality of printers designated previously by the user is displayed.

The present invention is also implemented by executing processing, described below. More specifically, software (a program) for implementing the function in the above-mentioned exemplary embodiment is supplied to a system or an apparatus via a network or various types of storage media, and a computer (or a CPU, a micro processing unit (MPU), etc.) in the system or the apparatus reads out and executes the program.

As described in each of the exemplary embodiments, the problem that the print setting screen of the printer intended by the user cannot be displayed by not installing the printer driver into the client PC is solved as follows:

1. An output destination printer is previously designated so that an optimum print setting screen can be generated and displayed unless a printer output by the client PC is selected.

2. If a printer output by the client PC is not designated, a general-purpose print setting screen can be generated and displayed according to a printer group managed by a print server.

Items 1 and 2 are thus automatically switched so that the print setting screen of the printer intended by the user can be displayed even in an environment where the printer driver is not installed into the client PC.

According to the exemplary embodiments of the present invention, the optimum print setting screen can be displayed depending on whether the user designates or does not designate the printer that the user desires to use for printing without installing the printer driver in the client PC (client apparatus).

Aspects of the present invention can also be realized by a computer of a system or apparatus (or devices such as a CPU or MPU) that reads out and executes a program recorded on a memory device to perform the functions of the above-described embodiment (s), and by a method, the steps of which are performed by a computer of a system or apparatus by, for example, reading out and executing a program recorded on a memory device to perform the functions of the above-described embodiment (s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2009-279825 filed Dec. 9, 2009, which is hereby incorporated by reference herein in its entirety.

What is claimed is:

1. A print server comprising:
a receiving unit configured to receive, from a printer, user information input in the printer;
a storage unit configured to store the user information received by the receiving unit;
an acquisition unit configured to acquire user information issued from a client apparatus; and
a generation unit configured to generate, when user information that matches the user information acquired by the acquisition unit is stored in the storage unit, a print setting screen based on a function of a printer associated with the user information, and to generate, when user information that matches the user information acquired by the acquisition unit is not stored in the storage unit, a print setting screen based on functions of a plurality of printers.

2. The print server according to claim 1, wherein the generation unit generates, when the user information that matches the user information acquired by the acquisition unit is stored and the plurality of printers exists as the printer associated with the user information, the print setting screen based on the functions of the plurality of printers.

3. The print server according to claim 1, further comprising a setting unit configured to set an effective period for the printer associated with the user information.

4. The print server according to claim 3, wherein the generation unit determines whether the effective period of the printer associated with the user information is effective when the user information that matches the user information acquired by the acquisition unit is stored, generates, when determining that the effective period of the printer associated with the user information is effective, the print setting screen based on the function of the printer, and generates, when determining that the effective period of the printer associated with the user information is not effective, a print setting screen based on a function of a printer designated previously by a user indicated by the user information.

5. The print server according to claim 1, further comprising a default printer setting unit configured to set the printer associated with the user information to a default printer.

6. A method for generating a print setting screen, the method comprising:
receiving, from a printer, user information input in the printer;
storing the received user information;
acquiring user information issued from a client apparatus; and
generating, when user information that matches the acquired user information is stored, a print setting screen based on a function of a printer associated with the user information, and generating, when user information that matches the acquired user information is not stored, a print setting screen based on functions of a plurality of printers.

7. The method according to claim 6, further comprising generating, when the user information that matches the acquired user information is stored and the plurality of printers exists as the printer associated with the user information, the print setting screen based on the functions of the plurality of printers.

8. The method according to claim 6, further comprising setting an effective period for the printer associated with the user information.

9. The method according to claim 8, further comprising determining whether the effective period of the printer associated with the user information is effective when the user information that matches the acquired user information is stored, generating, when determining that the effective period of the printer associated with the user information is effective, the print setting screen of the printer, and generating, when determining that the effective period of the printer associated with the user information is not effective, a print setting screen based on a function of a printer designated previously by a user indicated by the user information.

10. The method according to claim 6, further comprising setting the printer associated with the user information to a default printer.

11. A storage medium storing a program for performing a method for generating a print setting screen, the method comprising:
receiving, from a printer, user information input in the printer;
storing the received user information;
acquiring user information issued from a client apparatus; and
generating, when user information that matches the acquired user information is stored, a print setting screen based on a function of a printer associated with the user information, and generating, when user information that matches the acquired user information is not stored, a print setting screen based on functions of a plurality of printers.

12. The storage medium according to claim 11, wherein the method further comprises generating, when the user information that matches the acquired user information is stored and the plurality of printers exists as the printer associated with the user information, the print setting screen based on the functions of the plurality of printers.

13. The storage medium according to claim 11, wherein the method further comprises setting an effective period for the printer associated with the user information.

14. The storage medium according to claim 13, wherein the method further comprises determining whether the effective period of the printer associated with the user information is effective when the user information that matches the acquired user information is stored, generating, when determining that the effective period of the printer associated with the user information is effective, the print setting screen of the printer, and generating, when determining that the effective period of the printer associated with the user information is not effective, a print setting screen based on a function of a printer designated previously by a user indicated by the user information.

15. The storage medium according to claim 11, wherein the method further comprises setting the printer associated with the user information to a default printer.
